(19) United States
(12) Patent Application Publication
(10) Pub. No.: US 2005/0137298 A1
(43) Pub. Date: Jun. 23, 2005

(54) Imidazole-containing coating compositions with enhanced corrosion resistance

(76) Inventor: John R. Schneider, Glenshaw, PA (US)

Correspondence Address: PPG INDUSTRIES, INC.;Intellectual Property Department, One PPG Place, Pittsburgh, PA, 15272, US

(21) Appl. No.: 10/738,656

(22) Filed: Dec. 17, 2003

(51) Int. Cl. C08K 5/34

(52) U.S. Cl. 524/106

(57) ABSTRACT

Coating compositions having improved substrate adhesion and improved corrosion resistance are disclosed. The coatings comprise an imidazole compound added to a film-forming resin at a weight ratio sufficient to provide the desired level of adhesion and corrosion resistance. Methods of using the coatings, and the substrates coated therewith, are also disclosed.

### FIELD OF THE INVENTION

The present invention relates to coating compositions that possess improved substrate adhesion and corrosion resistance and to methods for using the same. More specifically, the improved adhesion and corrosion resistance is achieved by adding an imidazole compound to a film-forming resin.

### BACKGROUND OF THE INVENTION

“Color-plus-clear” coating systems involving the application of a colored or pigmented basecoat to a substrate followed by application of a transparent or clear topcoat over the basecoat have become increasingly popular as original finishes for a number of consumer products including, for example, cars and floor coverings such as ceramic tiles and wood flooring. The color-plus-clear coating systems have outstanding appearance properties, including gloss and distinctness of image, due in large part to the clear coat.

“Monocoat” coating systems comprising a one coat color layer are applied themselves as the topcoat; Monocoat coating systems are frequently used for household appliances, lawn and garden equipment, interior fixtures, and the like. The monocoats also have good appearance properties, including gloss and distinctness of image.

These coating systems, deposited and cured onto a substrate, can be subject to damage from the environment. For example, corrosion of a coated metallic substrate can occur as the coated metallic substrate is exposed to oxygen and water present in the atmosphere. It is known in the art that a “primer” coating layer is required when these coating systems are applied over metallic substrates to protect the substrate from corrosion. The primer layer is applied directly to the metallic substrate and contains pigments known in the art to prevent corrosion. These pigments are typically required at high concentrations for performance effectiveness and may adversely affect gloss and distinctness of image of the cured primer coating such that the color-plus-clear or monocoat coating is additionally required for improved appearance.

The primer coating layer also imparts greater adhesion of the entire coating system to the substrate surface. The primer coating layer provides greater adhesion of the monocoat or color-plus-clear coating to the substrate surface compared to similar coatings applied directly to the substrate with no primer coating layer.

It is known in the art that imidazole compounds are used as antioxidants in adhesives as well as natural and synthetic rubbers. The purpose of an antioxidant is to retard oxidation of the material into which it is incorporated.

Thus, there is a need in the coatings art for topcoats having good corrosion resistance and good adhesion when applied directly to a metallic substrate. This would eliminate the need for an additional primer layer in the painting process.

### SUMMARY OF THE INVENTION

The present invention is directed to coating compositions comprising a film-forming resin and an imidazole compound. The weight ratio of the imidazole compound to the film-forming resin is within the range of 0.50 to 10.0. Methods for using these compositions are also within the scope of invention, as are substrates coated according to these methods.

It has been discovered that the incorporation of an imidazole compound into a film-forming resin results in a cured coating having greater adhesion and corrosion resistance as compared to a cured coating deposited from a similar coating composition with no imidazole compound.

“Adhesion” refers herein to the state in which two surfaces are held together by interfacial forces. The two surfaces described herein include a cured coating surface and a substrate surface.

“Corrosion” refers herein to a gradual wearing away or alteration by a chemical or electrochemical oxidizing process. Corrosion occurs in the presence of oxygen and water. “Corrosion resistance” is a measure of a material's ability to resist degradation caused by corrosion.

“Appearance” refers herein to characterization of the cured coating by 20 degree gloss measurement. A cured coating that generates high numbers from this measurement has better appearance compared to a cured coating that generates low numbers from the same measurement.

### DESCRIPTION OF THE INVENTION

The present invention is directed to a coating composition comprising a film-forming resin and an imidazole compound.

Any resin that forms a film can be used according to the present methods, absent compatibility problems. For example, resins suitable for liquid coating compositions can be employed.

A particularly suitable resin for use in the present coating compositions is one formed from the reaction of a polymer having at least one type of reactive functional group and a curing agent having functional groups reactive with the functional group of the polymer. The polymers can be, for example, acrylic, polyester, polyurethane or polyether, and can contain functional groups such as epoxy, carboxylic acid, hydroxyl, isocyanate, amide, carbamate and carboxylate groups.

The acrylic polymers, if used, are typically copolymers of acrylic acid or methacrylic acid or hydroxyalkyl esters of acrylic or methacrylic acid such as hydroxyethyl methacrylate or hydroxypropyl acrylate with one or more other polymerizable ethylenically unsaturated monomers such as alkyl esters of acrylic acid including methyl methacrylate and 2-ethyl hexyl acrylate, and vinyl aromatic compounds such as styrene, alpha-methyl styrene and vinyl toluene. The ratio of reactants and reaction conditions are selected to result in an acrylic polymer with pendant hydroxyl or carboxylic acid functionality.

Besides acrylic polymers, the curable coating composition of the present invention can contain a polyester polymer or oligomer. Such polymers may be prepared in a known manner by condensation of polyhydric alcohols and polycarboxylic acids. Suitable polyhydric alcohols include ethylene glycol, neopentyl glycol, trimethylol propane and pentaerythritol.

Suitable polycarboxylic acids include adipic acid, 1,4-cyclohexyl dicarboxylic acid and hexahydrophthalic acid. Besides the polycarboxylic acids mentioned above, functional equivalents of the acids such as anhydrides where they exist or lower alkyl esters of the acids such as the methyl esters may be used. Also, small amounts of monocarboxylic acids such as stearic acid may be used.

Hydroxyl-containing polyester oligomers can be prepared by reacting an anhydride of a dicarboxylic acid such as hexahydrophthalic anhydride with a diol such as neopentyl glycol in a 1:2 molar ratio.

Where it is desired to enhance air-drying, suitable drying oil fatty acids may be used and include those derived from linseed oil, soya bean oil, tall oil, dehydrated castor oil or tung oil.

The polyesters are made to contain free terminal hydroxyl and/or carboxyl groups which are available for further crosslinking reactions.

Polyurethane polymers containing terminal isocyanate or hydroxyl groups may also be used. The polyurethane polyols or NCO-terminated polyurethanes which can be used are those prepared by reacting polyols including polymeric polyols with polyisocyanates. The polyurea-containing terminal isocyanate or primary or secondary amine groups which can be used are those prepared by reacting polyamines including polymeric polyamines with polyisocyanates. The hydroxyl/isocyanate or amine/isocyanate equivalent ratio is adjusted and reaction conditions selected to obtain the desired terminal group. Examples of suitable polyisocyanates are those described in U.S. Pat. No. 4,046,729 at column 5, line 26 to column 6, line 28, hereby incorporated by reference. Examples of suitable polyols are those described in U.S. Pat. No. 4,046,729 at column 7, line 52 to column 10, line 35, hereby incorporated by reference. Examples of suitable polyamines are those described in U.S. Pat. No. 4,046,729 at column 6, line 61 to column 7, line 32 and in U.S. Pat. No. 3,799,854 at column 3, lines 13 to 50, both hereby incorporated by reference.

Curing agents suitable for use in the curable coating composition of the present invention can include aminoplast resins and phenoplast resins and mixtures thereof, as curing agents for OH, COOH, amide, and carbamate functional group containing materials. Examples of aminoplast and phenoplast resins suitable as curing agents in the curable compositions of the present invention are those described in U.S. Pat. No. 3,919,351 at col. 5, line 22 to col. 6, line 25, hereby incorporated by reference.

Also suitable are polyisocyanates and blocked polyisocyanates as curing agents for OH and primary and/or secondary amino group-containing materials. Examples of polyisocyanates and blocked isocyanates suitable for use as curing agents in the curable compositions of the present invention are those described in U.S. Pat. No. 4,546,045 at col. 5, lines 16 to 38; and in U.S. Pat. No. 5,468,802 at col. 3, lines 48 to 60, both hereby incorporated by reference.

Anhydrides as curing agents for OH and primary and/or secondary amino group containing materials are well known in the art. Examples of anhydrides suitable for use as curing agents in the curable compositions of the present invention are those described in U.S. Pat. No. 4,798,746 at col. 10, lines 16 to 50; and in U.S. Pat. No. 4,732,790 at col. 3, lines 41 to 57, both hereby incorporated by reference.

Polyepoxides as curing agents for COOH functional group containing materials are well known in the art. Examples of polyepoxides suitable for use as curing agents in the curable compositions of the present invention are those described in U.S. Pat. No. 4,681,811 at col. 5, lines 33 to 58, hereby incorporated by reference.

Polyacids as curing agents for epoxy functional group containing materials are well known in the art. Examples of polyacids suitable for use as curing agents in the curable compositions of the present invention are those described in U.S. Pat. No. 4,681,811 at col. 6, line 45 to col. 9, line 54, hereby incorporated by reference.

Polyols, that is, material having an average of two or more hydroxyl groups per molecule, can be used as curing agents for NCO functional group containing materials and anhydrides and esters and are well known in the art. Examples of said polyols are those described in U.S. Pat. No. 4,046,729 at col. 7, line 52 to col. 8, line 9; col. 8, line 29 to col. 9, line 66; and in U.S. Pat. No. 3,919,315 at col. 2, line 64 to col. 3, line 33, both hereby incorporated by reference.

Polyamines can also be used as curing agents for NCO functional group containing materials and for carbonates and unhindered esters and are well known in the art. Examples of polyamines suitable for use as curing agents in the curable compositions of the present invention are those described in U.S. Pat. No. 4,046,729 at col. 6, line 61 to col. 7, line 26, hereby incorporated by reference.

When desired, appropriate mixtures of curing agents may be used. It should be mentioned that such curable compositions can be formulated as a one-component composition where a curing agent such as an aminoplast resin and/or a blocked isocyanate compound such as those described above is admixed with other composition components. The one-component composition can be storage stable as formulated. Alternatively, compositions can be formulated as a two-component composition where, for example, a polyisocyanate curing agent such as those described above can be added to a pre-formed admixture of the other composition components just prior to application. The pre-formed admixture can comprise curing agents for example, aminoplast resins and/or blocked isocyanate compounds such as those described above.

Examples of polymers useful in forming the resin in the coating compositions of the present invention include hydroxyl functional containing acrylic and polyester copolymers combined with a polyisocyanate curing agent.

The film-forming resin is generally present in the present coating compositions in an amount greater than about 30 weight percent, such as greater than about 40 weight percent, and less than 90 weight percent, with weight percent being based on the total solid weight of the composition. For example, the weight percent of resin can be between 30 and 90 weight percent. When a curing agent is used, it is generally present in an amount of up to 70 weight percent, typically between 10 and 70 weight percent; this weight percent is also based on the total solid weight of the coating composition.

The present compositions can be formed from film-forming resins that are liquid, that is, waterborne or solventborne systems. Preferred diluents are organic solvents, but water, usually water/organic solvent mixtures can be used. Organic solvents in which the present coating compositions may be dispersed include, for example, alcohols, ketones, aromatic hydrocarbons, glycol ethers, esters or mixtures thereof. The diluent is generally present in amounts ranging from 5 to 80 weight percent based on total weight of the composition, such as 30 to 50 percent.

The coating compositions of the present invention can also comprise optional ingredients such as those well known in the art of formulating surface coatings. Such optional ingredients can comprise, for example, surface active agents, flow control agents, thixotropic agents, fillers, anti-gassing agents, organic co-solvents, catalysts, antioxidants, light stabilizers, UV absorbers and other customary auxiliaries. Any such additives known in the art can be used, absent compatibility problems. Non-limiting examples of these materials and suitable amounts are described in U.S. Pat. Nos. 4,220,679; 4,403,003; 4,147,769; and 5,071,904, which patents are incorporated herein by reference. Typically each of the optional ingredients can be present in amounts as low as 0.01 weight percent and as high as 20.0 weight percent. Usually the total amount of optional ingredients will range for 0.01 to 25 weight percent. The weight percentage is based on total weight of the composition.

Examples of imidazole compounds include but are not limited to 2-mercaptotoluimidazole, zinc 2-mercaptotoluimidazole, 2-mercaptobenzimidazole, 2-aminobenzimidazole, 5-methylbenzimidazole, and 2-mercapto-5-methylbenzimidazole. Some of these compounds are commercially available. For example, 2 zinc-mercaptotoluimidazole is available from R.T. Vanderbilt Company, Inc. as Vanox® ZMTI; and 2-mercaptotoluimidazole is also available from R.T. Vanderbilt Company, Inc. as Vanox® MTI. The other compounds mentioned can be obtained from Aldrich.

The imidazole compound is typically present in the curable coating composition of the present invention in a weight ratio of imidazole compound to film-forming resin in the range of 0.50 to 10.0, preferably from 1.5 to 3.0. In one embodiment, the coating composition contains a weight ratio of carbon black pigment to film-forming resin of at least 0.04 and a weight ratio of imidazole compound to film-forming resin of at least 1.6. It will be appreciated that improvement of adhesion and corrosion resistance will increase as the concentration of imidazole compound increases. The tests described in the Example section below can be used by those skilled in the art to determine what weight percent of imidazole compound will give the desired level of protection.

The imidazole compound of the present invention can be added at any time during the formulation of the coating composition and should form a stable suspension in the film-forming resin. For example, curable coating compositions of the present invention can be prepared by first blending the film-forming resin, the imidazole compound and diluent in a closed container that contains ceramic grind media. The blend is subject to high shear stress conditions, such as by shaking it on a high speed shaker for several hours. The blend is subject to high shear stress until a homogeneous dispersion of imidazole compound remains suspended in the film-forming resin with no visible settle of the compound in the container. It should be understood that any mode of applying stress to the blend can be utilized, such as agitation with a high speed mechanical stirrer, so long as sufficient stress is applied to achieve a stable suspension of the imidazole compound in the film-forming resin.

Further, any combination of inorganic particles can be added to the film-forming resin containing the imidazole compound according to the present invention. Examples of inorganic particles include but are not limited to silica; aluminum silicate; borosilicate glass; nitrides including boron nitride and silicon nitride; oxides including titanium dioxide and zinc oxide; quartz; nepheline syenite; zircon such as in the form of zirconium oxide; buddeluyite; and eudialyte. Mixtures of any of the above particles can be used. In one embodiment, the particles in the coating compositions comprise borosilicate glass.

The particles listed above are widely commercially available. For example, crystalline silica is available from Reade Advanced Materials; amorphous and precipitated silica from PPG Industries, Inc; aluminum silicate particles from NanoMaterials Research Corporation; colloidal silica from Nissan Chemicals; borosilicate glass, sold as SUNSPHERES, from Suncolor Corporation; and quartz and nepheline syenite from Unimin, Inc. Other alumina products are available from Micro Abrasives Corporation as WCA3, WCA3S, and WCA3TO, and from Alcoa as TE4-20. Zircon, buddeluyite and eudialyte are commercially available from Aran Isles Corporation, and boron nitride is available from Carborundum Inc. as SHP-605 and HPP-325. It will be appreciated that many commercially available products are actually composites or alloys of one or more materials. Such particles are equally within the scope of the present invention.

The particles used in the present invention have a particle size range of 5 to 1000 nanometers, typically 5 to 700 nanometers. Any of the particles listed above can be used in any size within these ranges according to the present invention. In one embodiment, the particles such as borosilicate glass spheres have a particle size range of 5 to 600 nanometers. Particle size can be determined according to any method known in the art, such as by a conventional particle size analyzer. For particle sizes smaller than 1000 nanometers (1 micron), transmissional electron microscopy (“TEM”) can be used.

The particles used in the present invention have a surface area of between 5 and 150 square meters per gram. Any of the particles listed above can be used within these ranges according to the present invention. In one embodiment, the particles such as borosilicate glass spheres have a surface area between 13 and 16 square meters per gram. “Surface area” refers to the total area of exposed surface (area of contact between two different states of matter) of a finely divided solid including irregularities of all types.

Surface area can be determined according to any method known in the art, such as by BET.

The shape or morphology of the particles can vary depending on the type of particle or particles selected. For example, generally spherical particles, such as crystalline materials, solid beads, microbeads, or hollow spheres, can be used, as can particles that are plate-like, cubic or acicular (that is, elongated or fibrous). The particles can also have a random or non-uniform morphology. In addition, the particles can have an internal structure that is hollow, porous or void free, or any combination, such as a hollow center with porous or solid walls. It will be appreciated that different particle shapes may be more suitable for one application over another. Particle shape may be irrelevant, however, for other applications. It will be appreciated that combinations of particles having different morphologies can be used to give the desired characteristics to the final coating.

The particles used in the present invention may be a mixture of particles of different sizes. The mixture may comprise 10 to 50 weight percent of particles having a particle size within the range of 5 up to 400 nanometers and 50 to 90 weight percent of particles having a particle size within the range of 400 to 1000 nanometers. In one embodiment, the particles such as a mixture of borosilicate glass spheres have different particle sizes. The mixture comprises 10 to 50 weight percent of the particles having a particle size within the range of 5 up to 400 nanometers and 50 to 90 weight percent of the particles having a particle size within the range of 400 to 1000 nanometers.

The particles are typically present in the curable coating composition of the present invention in a weight ratio of particles to film-forming resin of 0.2 to 2.0. In one embodiment, the coating composition contains a weight ratio of imidazole compound to film-forming resin of at least 1.6 and a weight ratio of particles to film-forming resin of at least 0.2. It will be appreciated that improvement in corrosion resistance will increase as the concentration of particles increases. The tests described in the Example section below can be used by those skilled in the art to determine what weight percent of particles will give the desired level of protection.

The particles of the present invention can be added at any time during the formulation of the coating composition and should form a stable suspension in the film-forming resin. For example, curable coating compositions of the present invention can be prepared by first blending the film-forming resin, the plurality of particles and diluent in a closed container that contains ceramic grind media. The blend is subject to high shear stress conditions, such as by shaking it on a high speed shaker for several hours. The blend is subject to high shear stress until a homogeneous dispersion of particles remains suspended in the film-forming resin with no visible particle settle in the container. It should be understood that, if desired, any mode of applying stress to the blend can be utilized, so long as sufficient stress is applied to achieve a stable suspension of the particles in the film-forming resin.

The coating compositions of the present invention may be used to form a single coating, for example, a monocoat, a clear topcoat or a basecoat in a two-layered system or both; or as one or more layers of a multi-layered system including a clear topcoat composition, a colorant layer and/or a basecoat composition, and/or a primer layer.

As would be understood by one skilled in the art, coating film thickness and curing temperatures and conditions will depend upon the type of coating layer to be formed, i.e., a primer coating, a basecoat, a clear topcoat, a monocoat; as well as the coating composition itself, i.e., whether thermosetting or thermoplastic, whether ambient or thermally curable, and, if thermosetting, the type of curing reaction required.

The coating compositions of the present invention can be applied by any conventional method such as brushing, dipping, flow coating, roll coating, conventional and electrostatic spraying. Spray techniques are most often used. Typically, film thickness for cured coatings is at least 0.5 mils and can range between 0.5 and 5 mils.

Several coating compositions can be cured at ambient temperature, such as those having a polyisocyanate or polyanhydride curing agent, or they can be cured at minimally elevated temperatures to hasten the cure. An example would be forced air curing in a down draft booth at about 40° C. to 60° C., which is common in the automotive refinish industry. The ambient temperature curable compositions are usually prepared as a two (2) package system (“2K”) in which the ambient curing agent (“crosslinker pack”) is kept separate from the film-forming resin (“resin pack”) containing the reactive functional group. The packages are combined shortly before application.

The thermally curable coating compositions such as those using blocked isocyanate, aminoplast, phenoplast, polyepoxide or polyacid curing agent can be prepared as a one-package system (“1K”). These compositions are cured at elevated temperatures, typically for 1 to 30 minutes at about 250° F. to about 450° F. (121° C. to 232° C.) with temperature primarily dependent upon the type of substrate used. Dwell time (i.e., time that the coated substrate is exposed to elevated temperature for curing) is dependent upon the cure temperatures used as well as wet film thickness of the applied coating composition. For example, coated automotive elastomeric parts require a long dwell time at a lower cure temperature (e.g., 30 minutes at 250° F. (121° C.)), while coated aluminum beverage containers require a very short dwell time at a very high cure temperature (e.g., 1 minute at 375° F. (191° C.)). 1K systems can also be cured by exposure to actinic radiation, such as UV light or electron beam.

The coating compositions of the present invention can be applied to a variety of substrates, for example, automotive substrates such as fenders, hoods, doors and bumpers, and industrial substrates such as household appliances, including washer and dryer panels and lids, refrigerator doors and side panels, lighting fixtures and metal office furniture. Such automotive and industrial substrates can be metallic, for example, aluminum, galvanized steel and untreated steel.

The coating compositions of the invention are particularly useful as topcoats and/or basecoats in color-plus-clear compositions. The coating compositions of the invention in the pigmented form can be applied directly to a substrate to form a colorcoat (either a colored basecoat or a colored topcoat). When used as a colored topcoat, coating thicknesses of about 0.5 to 5.0 mils are usual. When used as a colored basecoat, thicknesses of about 0.1 to 2.0 mils are usual.

Accordingly, the present invention is further directed to a metallic substrate, such as galvanized steel, coated directly with one or more of the present compositions. The compositions, and manner of applying the same, are as described above.

In one embodiment, the present invention is directed to a method for improving the adhesion and corrosion resistance of a substrate comprising applying the coating composition comprising a film-forming resin and an imidazole compound to at least a portion of the substrate. Application can be by any means known in the art to the thicknesses described above. The cured coating has at least 10 percent greater adhesion and at least 10 percent greater corrosion resistance when deposited directly on galvanized steel substrate as compared to a similar coating with no imidazole compound.

In another embodiment, the present invention is directed to a method for improving the adhesion and corrosion resistance of a substrate comprising applying the coating composition comprising a film-forming resin and an imidazole compound and a plurality of particles to at least a portion of the substrate. The cured coating has at least 10 percent greater adhesion and at least 10 percent greater corrosion resistance when deposited directly on galvanized steel substrate as compared to a similar coating with no imidazole compound and no particles.

Appearance of the cured coating is characterized by 20 degree gloss. This test is known in the art as a technique to measure appearance of a cured coating. A cured coating generating high numbers from 20 degree gloss has better appearance compared to a cured coating generating low numbers from the same measurements. Monocoats possessing good appearance typically have a minimum 20 degree gloss measurement of 75 units.

As used herein, the term “adhesion” refers to the state in which two surfaces are held together by interfacial forces. The surfaces described herein include a coating surface and a substrate surface.

A useful test known in the art to measure adhesion of a cured coating to a substrate involves the use of a cutting edge to cut two sets of ten (10) parallel lines through the cured coating to the substrate surface. First, ten parallel lines are cut spaced two (2) millimeters apart with the aid of a spacing template. Each line is approximately two (2) inches in length. Then, a second set of ten (10) parallel lines is cut perpendicular to the first set. Each line is also approximately two (2) inches in length. The result is a grid of 100 squares. A piece of 3M Tape #898 (approximately 3 inches long) is placed over the scribed grid and firmly smoothed to ensure good contact. Within ninety (90) seconds of tape application, the tape is rapidly pulled off in one continuous motion. The pulling action is directed toward the test performer while keeping the tape as close as possible to a 60-degree angle.

The scribed area is inspected for removal of cured coating surface from the substrate surface. ASTM D3359 is used to rate the adhesion results on a scale from 0 to 10. If a test panel receives a rating of zero (0), there is no adhesion of the cured coating surface to the substrate surface. If a test panel receives a rating of ten (10), the cured coating surface has complete adhesion to the substrate surface.

As used herein, the term “corrosion” refers to a gradual wearing away or alteration by a chemical or electrochemical oxidizing process. Metallic substrates corrode in the presence of oxygen and water. The corrosion process is caused by a flow of electricity from one metal to another metal, and the presence of an electrolyte, such as salt, is essential for the process to occur. “Corrosion resistance” is the measurement of corrosion prevention on the metal substrate.

A useful test known in the art to measure the corrosion resistance of coated substrate is ASTM B117 (Salt Spray Test). In this test, the coated substrate is scribed with a knife to expose the bare metal substrate. The scribed substrate is placed into a test chamber where an aqueous salt solution is continuously misted onto the substrate. The chamber is maintained at constant temperature. In one embodiment of the present invention, the coated substrate is exposed to the salt spray environment for 250 hours. After exposure, the coated substrate is removed from the test chamber and evaluated for corrosion along the scribe. Corrosion is measured by “scribe creep”, defined as the total distance the corrosion has traveled across the scribe measured in millimeters.

The coatings formed according to the present invention, when cured, can have greater adhesion and greater corrosion resistance properties as compared to a similar coating with no imidazole compound. “Greater adhesion” is defined as more cured coating surface adhering to the substrate surface as compared to a similar coating with no imidazole compound. “Greater corrosion resistance” is defined as less scribe creep as measured in millimeters compared to a similar coating with no imidazole compound.

As used herein, unless otherwise expressly specified, all numbers such as those expressing values, ranges, amounts or percentages may be read as if prefaced by the word “about”, even if the term does not expressly appear. Also, any numerical range recited herein is intended to include all sub-ranges subsumed therein. As used herein, the term “polymer” refers to oligomers and both homopolymers and copolymers, and the prefix “poly” refers to two or more.

Illustrating the invention are the following examples that are not to be considered as limiting the invention to their details. All parts and percentages in the examples, as well as throughout the specification, are by weight unless otherwise indicated.

### EXAMPLES

The following examples are intended to illustrate the invention, and should not be construed as limiting the invention in any way.

### Example 1

The imidazole compound was formulated into the resin-containing portion of the two-pack liquid coating compositions of Samples 2 through 7, the components of which are listed in grams in Table 1. Samples 8 and 9 were included to compare the performance of these compounds listed in Table 1 to the imidazole compounds. By way of comparison with Samples 2 through 9, Sample 1 was prepared with no imidazole compound by sequential mixing of each component using a Cowles blade.

The imidazole compounds in Samples 2 through 7, as well as the compounds present in Samples 8 and 9, were incorporated by first mixing the compound with polyester resin, Chisorb 328, Tinuvin 292, and n-Butyl acetate in the amounts shown in Table 1. This mixture was milled in a four (4) ounce sealed jar containing zircoa grind media for two (2) hours on a high speed shaker. After this, additional ingredients of Joncryl 500, Ircogel 906, and Dibutyl Tin Dilaurate were added to the mixture and milled on a high speed shaker for an additional ten (10) minutes. After milling was complete, the material was removed from the sealed jar and filtered to remove the grind media. Toner F3547 was then added to the milled mix at the amount shown in Table 1. This mixture is named the “Resin Pack”. The “Crosslinker Pack” was prepared by mixing the components in the amounts shown in Table 1.

TABLE 1

| | Sample | | | | | | | | |
|---|---|---|---|---|---|---|---|---|---|
| | 1 | 2 | 3 | 4 | 5 | 6 | 7 | 8 | 9 |
| “Resin Pack” | | | | | | | | | |
| Polyester resin¹ | 14.29 | 14.29 | 14.29 | 14.29 | 14.29 | 14.29 | 14.29 | 14.29 | 14.29 |
| Chisorb 328² | 1.42 | 1.42 | 1.42 | 1.42 | 1.42 | 1.42 | 1.42 | 1.42 | 1.42 |
| Tinuvin 292³ | 0.93 | 0.93 | 0.93 | 0.93 | 0.93 | 0.93 | 0.93 | 0.93 | 0.93 |
| n-Butyl acetate⁴ | 13.17 | 13.17 | 12.94 | 13.17 | 13.17 | 13.17 | 13.17 | 13.17 | 13.17 |
| Vanox ZMTI⁵ | — | 1.79 | — | — | — | — | — | — | — |
| Vanox MTI⁶ | — | — | 1.79 | — | — | — | — | — | — |
| 2-Mercapto⁷benzimidazole | — | — | — | 1.79 | — | — | — | — | — |
| 2-Aminobenzimidazole⁸ | — | — | — | — | 1.79 | — | — | — | — |
| 5-Methyl benzimidazole⁹ | — | — | — | — | — | 1.79 | — | — | — |
| 2-Mercapto-5-methyl benzimidazole¹⁰ | — | — | — | — | — | — | 1.79 | — | — |
| 1-Hydroxypyridine-2-thione¹¹ | — | — | — | — | — | — | — | 1.79 | — |
| Benzyl Zimate¹² | — | — | — | — | — | — | — | — | 1.79 |
| Joncryl 500¹³ | 18.90 | 18.90 | 18.90 | 18.90 | 18.90 | 18.90 | 18.90 | 18.90 | 18.90 |
| Dibutyl tin dilaurate¹⁴ | 0.09 | 0.09 | 0.09 | 0.09 | 0.09 | 0.09 | 0.09 | 0.09 | 0.09 |
| Ircogel 906¹⁵ | 1.87 | 1.87 | 1.87 | 1.87 | 1.87 | 1.87 | 1.87 | 1.87 | 1.87 |
| Toner F3547¹⁶ | 49.34 | 49.34 | 49.34 | 49.34 | 49.34 | 49.34 | 49.34 | 49.34 | 49.34 |
| “Crosslinker Pack” | | | | | | | | | |
| Tolonate HDTLV¹⁷ | 19.29 | 19.29 | 19.29 | 19.29 | 19.29 | 19.29 | 19.29 | 19.29 | 19.29 |
| Luxate IT1073¹⁸ | 19.47 | 19.47 | 19.47 | 19.47 | 19.47 | 19.47 | 19.47 | 19.47 | 19.47 |
| Silquest A-187¹⁹ | 6.61 | 6.61 | 6.61 | 6.61 | 6.61 | 6.61 | 6.61 | 6.61 | 6.61 |
| DT870²⁰ | 31.62 | 31.62 | 31.62 | 31.62 | 31.62 | 31.62 | 31.62 | 31.62 | 31.62 |

¹Polyester resin, formed from isostearic acid, 1,4-cyclohexanedicarboxylic acid, and trimethylol propane (39.2/23.8/37.0 weight ratio) at 93% solids in methyl n-amyl ketone and xylene (56.8/43.2 weight ratio).
²Chisorb 328, acrylic resin from Chitec Chemical Company.
³Tinuvin 292, liquid hindered amine light stabilizer from CIBA Specialty Chemicals.
⁴n-Butyl acetate, solvent from BASF Corporation.
⁵Vanox ZMTI, 2 zinc-mercaptotoluimidazole from R.T. Vanderbilt Company, Inc.
⁶Vanox MTI, 2-mercaptotoluimidazole from R.T. Vanderbilt Company, Inc.
⁷2-mercaptobenzimidazole, available from Aldrich.
⁸2-aminobenzimidazole, available from Aldrich.
⁹5-methylbenzimidazole, available from Aldrich.
¹⁰2-mercapto-5-methylbenzimidazole, available from Aldrich.
¹¹1-hydroxypyridine-2-thione, available from Aldrich.
¹²Benzyl zimate, available from R.T. Vanderbilt Company, Inc.
¹³Joncryl 500, polyester resin from SC Johnson & Son.
¹⁴Dibutyl tin dilaurate, tin catalyst from Air Products & Chemicals, Inc.
¹⁵Ircogel 906, rheology control additive from Lubrizol Corporation.
¹⁶Toner F3547, Delfleet Evolution Carbon Black Tinter from PPG Industries, Inc.
¹⁷Tolonate HDTLV, hexamethylene diisocyanate trimer from Rhodia.
¹⁸Luxate IT1073, polyisocyanate from Lyondell.
¹⁹Silquest A-187, silane from Crompton Corp.
²⁰DT870, solvent blend from PPG Industries, Inc.

The “Resin Pack” was co-blended with the “Crosslinker Pack” just prior to substrate application via handspray using a DeVilbiss GTI HVLP spray gun with a 1.4 tip. Samples 1 through 9 were spray applied directly to APR10288 cold roll steel test panels; APR18661 E60 EZG 60G test panels; and APR21047 aluminum 2024T3 unpolish test panels, available from ACT Laboratories. One pass was applied followed by an ambient flash for ten (10) minutes and then a second pass was applied. A target dry film thickness of 1.5 to 3.5 mils was applied. All coated substrates were allowed to cure at ambient conditions for seven (7) days prior to testing.

In addition to the coatings from Table 1, the same substrates were coated with a primer and topcoat system commonly used as a standard in the industry. The primer, commercially available from PPG Industries, Inc. as DP40LF Non Sanding Epoxy Primer was mixed with DP401 LF Epoxy Primer Catalyst at a 2 to 1 volumetric ratio per instructions on the technical data sheet and spray applied using conventional spray equipment. The applied coating was allowed to flash at ambient conditions for 30 minutes prior to spray application of Delfleet Evolution Topcoat, also commercially available from PPG Industries, Inc. The topcoat was prepared per instruction of the technical data sheet by mixing Delfleet Evolution F3547 Carbon Black Tinter with F3115 HS High Build Binder at a 1 to 1 weight ratio. This mixed package was then blended with F3260 HS Hardener and F3330 Medium Compliant Thinner at a 3 to 1 to 1 volumetric ratio. The blended topcoat was spray applied using a DeVilbiss GTI HVLP spray gun with a 1.4 tip at a target dry film thickness of 1.0 to 1.5 mils.

After ambient cure, the coated substrates were tested for dry film thickness, adhesion and 250 hours salt spray resistance. Dry film thickness was measured using the Fisherscope MMS (Multi-measuring System) instrument. The appropriate probe was chosen to measure the dry film thickness of each coating. The value is reported in Table 2 in mils.

Adhesion of the cured coating to the substrate was measured by cutting two sets of ten (10) parallel lines through the cured coating to the substrate surface using a cutting edge. First, ten parallel lines were cut spaced two (2) millimeters apart with the aid of a spacing template. Each line was approximately two (2) inches in length. Then, a second set of ten (10) parallel lines was cut perpendicular to the first set. Each line was also approximately two (2) inches in length. The result was a grid of 100 squares. A piece of 3M Tape #898 (approximately 3 inches long) was placed over the scribed grid and firmly smoothed to ensure good contact. Within ninety (90) seconds of tape application, the tape was rapidly pulled off in one continuous motion. The pulling action was directed toward the test performer while keeping the tape as close as possible to a 60-degree angle.

Next, the scribed area was inspected for removal of cured coating surface from the substrate surface. ASTM D3359 was used to rate the adhesion results on a scale from 0 to 10. A test panel with a rating of zero (0) indicates there was no adhesion of the cured coating surface to the substrate surface. A test panel with a rating of ten (10) indicates the cured coating surface had complete adhesion to the substrate surface.

Salt spray resistance was tested as described in ASTM B117. Panels removed from salt spray testing were measured for scribe creep across the scribe. Scribe creep values were reported as an average of six (6) measurements. Results from the above-mentioned tests are reported in the following Table 2.

TABLE 2

| | | | | | | Corrosion Resistance | | |
|---|---|---|---|---|---|---|---|---|
| | | | Adhesion | | | Scribe creep in millimeters | | |
| | Weight ratio | Dry film | APR | APR | APR | APR | APR | APR |
| | Black:Film- | Thickness | 10288 | 18661 | 21047 | 10288 | 18661 | 21047 |
| | forming resin | (mils) | CRS | EZG 60G | Aluminum | CRS | EZG 60G | Aluminum |
| Primer/Topcoat | — | 3.96 | 10/7 | 10/7 | 10/10 | 7.2 | 3.8 | 0.6 |
| Standard | | total | | | | | | |
| Sample 1 | 0.04 | 1.87 | 10 | 1 | 2 | 34.3 | 16.4 | 11.8 |
| (Comparative) | | | | | | | | |
| Sample 2 | 0.04 | 3.36 | 10 | 10 | 10 | 15.2 | 5.1 | 1.0 |
| Sample 3 | 0.04 | 1.78 | 10 | 10 | 10 | 9.3 | 8.3 | 2.3 |
| Sample 4 | 0.04 | 1.99 | 10 | 10 | 10 | 15.1 | 6.8 | 1.4 |
| Sample 5 | 0.04 | 1.88 | 10 | 10 | 10 | 17.3 | 7.8 | 1.0 |
| Sample 6 | 0.04 | 1.78 | 10 | 10 | 10 | 16.7 | 2.3 | 2.1 |
| Sample 7 | 0.04 | 1.97 | 10 | 10 | 10 | 19.0 | 5.8 | 1.2 |
| Sample 8 | 0.04 | 1.71 | 10 | 9 | 2 | 24.3 | 9.8 | 6.9 |
| Sample 9 | 0.04 | 2.08 | 10 | 8 | 0 | 17.7 | 12.2 | 13.6 |

As can be seen in Table 2, the use of the imidazole compound in the coating compositions (Samples 2 through 7) gave improved corrosion resistance as compared to Sample 1 with no imidazole compound. In addition, the cured coatings containing the imidazole compound (Samples 2 through 7) had complete adhesion over cold roll steel as did the comparative Sample 1. Samples 2 through 7 showed improved adhesion over EZG 60G and aluminum substrates compared to Sample 1 with no imidazole compound.

### Example 2

The imidazole compound was formulated into the resin-containing portion of the two-pack liquid coating compositions of Samples 11 through 14, the components of which are listed in grams in Table 3. By way of comparison with Samples 11 through 14, Sample 10 was prepared with no imidazole compound by sequential mixing of each component using a Cowles blade.

The imidazole compound in Samples 11 through 14 was incorporated by first mixing the compound with polyester resin, Chisorb 328, Tinuvin 292, and n-Butyl acetate in the amounts shown in Table 3. This mixture was milled in a four (4) ounce sealed jar containing zircoa grind media for two (2) hours on a high speed shaker. After this, additional ingredients of Joncryl 500, Ircogel 906, and Dibutyl Tin Dilaurate were added to the mixture and milled on a high speed shaker for an additional ten (10) minutes. After milling was complete, the material was removed from the sealed jar and filtered to remove the grind media. Toner F3547 was then added to the milled mix at the amount shown in Table 3. This mixture is named the “Resin Pack”. The “Crosslinker Pack” was prepared by mixing the components in the amounts shown in Table 3.

TABLE 3

| Sample | 10 | 11 | 12 | 13 | 14 |
|---|---|---|---|---|---|
| “Resin Pack” | | | | | |
| Polyester resin | 13.02 | 13.02 | 13.02 | 13.02 | 13.02 |
| Chisorb 328 | 1.29 | 1.29 | 1.29 | 1.29 | 1.29 |
| Tinuvin 292 | 0.85 | 0.85 | 0.85 | 0.85 | 0.85 |
| n-Butyl acetate | 17.53 | 17.53 | 17.53 | 17.53 | 17.53 |
| Vanox ZMTI | — | 0.45 | 1.63 | 5.00 | 8.97 |
| Joncryl 500 | 17.21 | 17.21 | 17.21 | 17.21 | 17.21 |
| Dibutyl tin dilaurate | 0.09 | 0.09 | 0.09 | 0.09 | 0.09 |
| Ircogel 906 | 1.50 | 1.50 | 1.50 | 1.50 | 1.50 |
| Toner F3547 | 44.94 | 44.94 | 44.94 | 44.94 | 44.94 |
| “Crosslinker Pack” | | | | | |
| Tolonate HDTLV | 16.79 | 16.79 | 16.79 | 16.79 | 16.79 |
| Luxate IT1073 | 16.96 | 16.96 | 16.96 | 16.96 | 16.96 |
| Silquest A-187 | 6.02 | 6.02 | 6.02 | 6.02 | 6.02 |
| DT870 | 22.18 | 22.18 | 22.18 | 22.18 | 22.18 |

Samples 10 through 14, as well as the primer and topcoat standard described in Example 1, were applied to the substrates from Example 1 in the manner described. The coated substrates were tested as described in Example 1, and results from these tests are reported in the following Table 4.

TABLE 4

| | | | | | | Corrosion Resistance | | |
|---|---|---|---|---|---|---|---|---|
| | | | Adhesion | | | Scribe creep in millimeters | | |
| | Weight ratio | Dry film | APR | APR | APR | APR | APR | APR |
| | Black:Film- | Thickness | 10288 | 18661 | 21047 | 10288 | 18661 | 21047 |
| | forming resin | (mils) | CRS | EZG 60G | Aluminum | CRS | EZG 60G | Aluminum |
| Primer/Topcoat | — | 2.31/1.34 | 10 | 10 | 10 | 7.5 | 5.9 | <0.25 |
| Standard | | | | | | | | |
| Sample 10 | 0.04 | 1.50 | 0 | 3 | 9 | 31.7 | Complete | 15.1 |
| (Comparative) | | | | | | | Delamination | |
| Sample 11 | 0.04 | 2.11 | 0 | 0 | 9 | 27.8 | 17.2 | 11.3 |
| Sample 12 | 0.04 | 3.14 | 8 | 8 | 10 | 15.7 | 10.0 | 1.9 |
| Sample 13 | 0.04 | 2.92 | 9 | 10 | 10 | 11.9 | 3.0 | 1.0 |
| Sample 14 | 0.04 | 2.74 | 8 | 10 | 9 | 9.5 | 2.4 | 0.5 |

As can be seen in Table 4, the addition of imidazole compound to Samples 11 through 14 improved corrosion resistance as compared to Sample 10 with no imidazole compound. Also, adhesion was improved in Samples 12 through 14 versus Sample 10 with no imidazole compound.

### Example 3

Both the imidazole compound and plurality of particles were formulated into the resin-containing portion of the two-pack liquid coating composition of Sample 16, the components of which are listed in grams in Table 5. By way of comparison with Sample 16, Sample 15 was prepared with no imidazole compound and with no particles by sequential mixing of each component using a Cowles blade.

The imidazole compound and particles in Sample 16 were incorporated by first mixing the particles with Joncryl 500, polyester resin, Ircogel 906, DT870, and Solsperse 32500 in the amounts shown in Table 5. This mixture was milled in an eight (8) ounce sealed jar containing zircoa grind media for five (5) hours on a high speed shaker. After this, additional ingredients of Chisorb 328, Tinuvin 292, Dibutyl Tin Dilaurate, Vanox ZMTI, and n-Butyl acetate were added to the mixture and milled on a high speed shaker for an additional two (2) hours. After milling was complete, the material was removed from the sealed jar and filtered to remove the grind media. Toner F3547 was then added to the milled mix at the amount shown in Table 5. This mixture is named the “Resin Pack”. The “Crosslinker Pack” was prepared by mixing the components in the amounts shown in Table 5.

TABLE 5

| | Sample 15 | Sample 16 |
|---|---|---|
| “Resin Pack” | | |
| Joncryl 500 | 17.21 | 12.42 |
| Polyester resin | 13.02 | 9.40 |
| UVT Sunspheres 0.05 | — | 32.76 |
| KAT 25¹⁵ | | |
| Ircogel 906 | 1.50 | 1.08 |
| DT870 | — | 11.26 |
| Solsperse 32500 | — | 0.49 |
| Chisorb 328 | 1.29 | 0.93 |
| Tinuvin 292 | 0.85 | 0.61 |
| Dibutyl tin dilaurate | 0.09 | 0.06 |
| Vanox ZMTI | — | 1.17 |
| n-Butyl acetate | 17.53 | 12.65 |
| Toner F3547 | 44.94 | 32.44 |
| “Crosslinker Pack” | | |
| Tolonate HDTLV | 16.79 | 12.12 |
| Luxate IT1073 | 16.96 | 12.24 |
| Silquest A-187 | 6.02 | 4.34 |
| DT870 | 22.18 | 16.01 |

¹⁵UVT Sunspheres 0.05 KAT25, borosilicate glass particles from Suncolor Corporation.
Particle size = mixture of 25% by weight within 5 up to 400 nanometers and 75% by weight within 400 and 1000 nanometers.
Surface area = between 13 and 16 square meters per gram.

Samples 15 and 16, as well as the primer and topcoat standard described in Example 1, were applied to the substrates from Example 1 in the manner described. The coated substrates were tested as described in Example 1 with the additional measurement of 20 degree gloss, and results from these tests are reported in the following Table 6. The 20 degree gloss was measured using a BYK Gardner micro-TRI-gloss instrument by placing the instrument on the coated substrate and recording the number generated.

TABLE 6

| | | | | | | | Corrosion Resistance | | |
|---|---|---|---|---|---|---|---|---|---|
| | Weight ratio | | | Adhesion | | | Scribe creep in millimeters | | |
| | Particles:film- | | Dry film | APR | APR | APR | APR | APR | |
| | forming | 20 | Thickness | 10288 | 18661 | 21047 | 10288 | 18661 | APR 21047 |
| | resin | Gloss | (mils) | CRS | EZG 60G | Aluminum | CRS | EZG 60G | Aluminum |
| Primer/Topcoat | — | 86.0 | 3.25 | 10 | 10 | 10 | 10.4 | 4.3 | 0.7 |
| Standard | | | total | | | | | | |
| Sample 15 | — | 87.4 | 1.87 | 10 | 1 | 2 | 34.3 | 16.4 | 11.8 |
| (Comparative) | | | | | | | | | |
| Sample 16 | 0.50 | 83.3 | 3.22 | 10 | 7 | 10 | 12.0 | 3.8 | 0.6 |

As can be seen in Table 6, the addition of imidazole compound and particles to Sample 16 improved adhesion and corrosion resistance as compared to Sample 15 with no imidazole compound and no particles.

Whereas particular embodiments of this invention have been described above for purposes of illustration, it will be evident to those skilled in the art that numerous variations of the details of the present invention may be made without departing from the invention as defined in the appended claims.

1. A coating composition comprising:
a) a film-forming resin; and
b) an imidazole compound, the weight ratio of (b) to (a) being in the range of 0.5 to 10.0, wherein the weight ratio of (b) to (a) imparts greater adhesion and greater corrosion resistance of a cured coating deposited from the coating composition compared to a cured coating deposited from a similar coating composition with no imidazole compound of (b).

2. The coating composition of claim 1 in which the imidazole compound is selected from the group consisting of 2-mercaptotoluimidazole, zinc 2-mercaptotoluimidazole, 2-mercaptobenzimidazole, 2-amino benzimidazole, 5-methyl benzimidazole, and 2-mercapto-5-methylbenzimidazole.

3. The coating composition of claim 2 wherein said imidazole compound is a mercapto imidazole compound.

4. The coating composition of claim 1, wherein the film-forming resin comprises at least one reactive functional group containing polymer and at least one curing agent having functional groups reactive with the functional group of the polymer.

5. The coating composition of claim 4, wherein the polymer is selected from the group consisting of acrylic polymers, polyester polymers, polyurethane polymers, and polyether polymers.

6. The coating composition of claim 5, wherein the polymer comprises reactive functional groups selected from the group consisting of epoxy groups, carboxylic acid groups, hydroxyl groups, isocyanate groups, amide groups, carbamate groups, carboxylate groups and mixtures thereof.

7. A substrate coated directly with the coating composition of claim 1; the coating composition containing a weight ratio of carbon black pigment to film-forming resin of at least 0.04, and a weight ratio of imidazole compound to film-forming resin of at least 0.5; the cured coating deposited from the coating composition having at least 10.0 percent greater adhesion and at least 10.0 percent greater corrosion resistance after 250 hours salt spray exposure as compared to a similar coating with no imidazole compound.

8. The substrate of claim 7, wherein said substrate is metallic.

9. The substrate of claim 8, wherein said metallic substrate is selected from the group consisting of aluminum, galvanized steel, and untreated steel.

10. The substrate of claim 9, wherein said metallic substrate is galvanized steel.

11. The substrate of claim 7, wherein the cured coating is at least 0.5 mils thick.

12. The substrate of claim 11, wherein the cured coating is between 0.5 and 5.0 mils thick.

13. A method for improving the corrosion resistance of a substrate comprising applying to at least a portion of the substrate the coating of claim 1.

14. The coating composition of claim 1, wherein the resultant cured coating, when deposited directly on galvanized steel substrate has at least 10 percent greater adhesion and at least 10 percent greater corrosion resistance as compared to a similar coating with no imidazole compound.

15. The coating composition of claim 1, wherein the coating composition further comprises a plurality of particles having a particle size range of 5 to 1000 nanometers dispersed in said resin, the weight ratio of particles to film-forming resin being in the range of 0.2 to 2.0.

16. The coating composition of claim 15, wherein said particles are inorganic.

17. The coating composition of claim 16, wherein said inorganic particles are selected from the group consisting of silica, aluminum silicate, borosilicate glass, nitrides, oxides, quartz, nepheline syenite, zircon, buddeluyite, and eudialyte.

18. The coating composition of claim 15, wherein the particles have a particle size range of 5 to 700 nanometers.

19. The coating composition of claim 15, wherein the particles have a surface area of between 5 and 150 square meters per gram.

20. The coating composition of claim 15, wherein said plurality of particles is a mixture of particles of different sizes.

21. The coating composition of claim 20, wherein the mixture comprises 10 to 50 percent by weight of particles having a particle size within the range of 5 up to 400 nanometers and 50 to 90 percent by weight of particles having a particle size within the range of 400 to 1000 nanometers.

22. The coating composition of claim 15, wherein said particles are spherical.

23. The coating composition of claim 15, wherein said particles are non-uniform in morphology.

24. The coating composition of claim 15, wherein said particles are plate-like.

25. A substrate coated directly with the coating composition of claim 15; the coating composition containing a weight ratio of imidazole compound to film-forming resin of at least 0.5, and a weight ratio of particles to film-forming resin of at least 0.2; the cured coating deposited from the coating composition having a 20 degree gloss of at least 75 units and at least 10 percent greater corrosion resistance after 250 hours salt spray exposure as compared to a similar coating with no imidazole compound and with no particles.

26. The substrate of claim 25, wherein the corrosion resistance is at least 50 percent greater.

27. The substrate of claim 25, wherein said substrate is metallic.

28. The substrate of claim 27, wherein said metallic substrate is selected from the group consisting of aluminum, galvanized steel, and untreated steel.

29. The substrate of claim 28, wherein said metallic substrate is untreated steel.

30. The substrate of claim 25, wherein the cured coating is at least 0.5 mils thick.

31. The substrate of claim 30, wherein the cured coating is between 0.5 and 5.0 mils thick.

32. A method for improving the corrosion resistance of a substrate comprising applying to at least a portion of the substrate the coating of claim 15.

33. The coating composition of claim 15 containing a weight ratio of imidazole compound to film forming resin of at least 0.5, and a weight ratio of particles to film forming resin of at least 0.2; wherein the resultant cured coating from the coating composition, when deposited directly on untreated steel substrate has a 20 degree gloss of at least 75 units and at least 10 percent greater corrosion resistance after 250 hours salt spray exposure as compared to a similar coating with no imidazole compound and with no particles.

34. The coating composition of claim 33, wherein the corrosion resistance is at least 50 percent greater.
